(19) United States
(12) Patent Application Publication
(10) Pub. No.: US 2004/0098280 A1
(43) Pub. Date: May 20, 2004

(54) System and method for providing author classifieds, interactive reading guides and related items for sale to book clubs

(76) Inventor: Pauline Hubert, New York, NY (US)

Correspondence Address: Jennifer Meredith, Suite 7720, 350 Fifth Avenue, New York, NY, 10118, US

(21) Appl. No.: 10/374,345

(22) Filed: Feb. 26, 2003

Related U.S. Application Data
(63) Continuation-in-part of application No. 10/295,353, filed on Nov. 15, 2002.

(51) Int. Cl. G06F 17/60

(52) U.S. Cl. 705/1

(57) ABSTRACT

The present invention provides systems and methods for facilitating discussion over a network between authors and readers, where the readers may be members of a book club. A method for providing a targeted author classified to at least one interested person and facilitating discussion regarding the targeted author classified comprising the steps of: receiving and storing in computer readable memory author information from at least one author; receiving and storing in computer readable memory at least one author classified from at least one author for at least one author classified item; receiving and storing in computer readable memory information regarding at least one reader; and presenting at least one author classified to said at least one reader, wherein said at least one author classified is selected according to information received and stored regarding said at least one reader.

This application is a continuation-in-part application under 37 CFR 1.53 (b) of application Ser. No. 10/295,353 filed Nov. 15, 2002.

### BACKGROUND OF THE INVENTION

This invention relates generally to systems and methods for providing an author with a quick and easy and interactive way to promote their writings to members of a book club. In this way, their promotion efforts are easy and targeted. The author may directly target people having an interest, background or profile they believe would be interested in the writing.

Traditionally, groups or forums (e.g. book clubs) meet periodically to discuss topics of interest (e.g. books). There may be a round table discussion, or a leader. Attendees may glean from the insight of others and realize an enhanced learning experience. Currently, people may agree to meet, may send out meeting notices via mail, email, etc., and proceed to find a location in which to meet. Authors typically have no way in which to communicate to their readers.

Computer networks, such as the Internet, have dramatically changed the way the people communicate with each other and get information about topics that interest them. Tools such as electronic mail (e-mail) and instant messaging are rapidly eclipsing conventional printed and mailed communications, and on-line versions of publications such as newspapers and magazines expand the availability of information previously available only to a few. The Internet is also allowing collaboration and providing information (and ways of getting it) that has few equivalents in the non-Internet world. For example, search engines such as Yahoo and Lycos enable users to rapidly and instantly get huge quantities of information and data about virtually any topic of interest, such as travel destinations, a favorite entertainer, a potential employer, and the like. Other sources of information on the Internet include bulletin boards, chat groups, and newsgroups such as USENET. These latter information sources give everyone with access to the Internet a way to “speak out” to a virtually unlimited audience at any time and at little or no cost, providing useful information, wisdom, tips, tricks, questions and answers, running commentary, criticism, anecdotes, and more, directly from Internet users, on virtually any and every topic.

To access the information in newsgroups such as USENET, sites such as www.altavista.com and www.deja.com provide search engines enabling users to search for posts directly related to specific topics. For example, a user can search a group such to view posts related to a topic such as “Jonathan Franzen.” This may turn up a great deal of information regarding the author, and topics of interest to readers. Although it is sometimes possible to find information directly on topic, posted by legitimate readers, one often has to sift through thousands of messages related to a given topic, reading each one, to determine if a post has personal relevance to a user or group. Another disadvantage is the prevalence of SPAM (unsolicited commercial email messages) and other advertisements disguised as “genuine” posts to such groups. Consequently, newsgroups are not a convenient or, more importantly, relevant source of information for many consumers, particularly those looking for information regarding books.

Online forums, though, have been lacking in that the information is difficult to sift through, may not be targeted and may not provide many of the benefits that face to face interaction can. Also, many members enjoy human interaction, and the feeling of belonging to a group where they know the members personally. Offline book clubs have served the purposes of providing a forum for individuals to get together, discussing and learning from one another, and providing an environment to meet others sharing a common interest. Heretofore, there has not been a system and methods for authors to get in touch with book clubs.

Previous systems and methods do not provide for communication between an author and a book club, provide efficient inter-group communication among similar interest groups, provide author classifieds with items for sale related to the group, allow the author to provide discussion questions, provide links to relevant sites, post book information, provide reading guides by the author and provide suggestions based upon group membership. Accordingly, there is a need within the prior art to provide a system and method for facilitating communication between the author and readers within a book club, providing pre-meeting topics, inter-group communication and discussion, where authors may sign up quickly and easily and author classifieds may provide items for sale.

### SUMMARY OF THE INVENTION

It is envisioned that the present invention may be utilized as a stand alone system, website, or a portion of a website. According to one aspect of the present invention, a system for authors to efficiently promote their books to interested persons via a communications network is disclosed, the system comprising: an author module for collecting and storing author information; an item module for collecting and storing book and writing information relating to at least author classified; an interface for displaying author information and at least one author classified written by the author; a book club module for collecting and storing book club information relating to a book club comprised of an least one member; and an interface for mediating communications via the communication network between the members of the book club and the author, and providing information from the author module, the item module, and the book club module to provide discussion topics and offers at least one targeted author classified for sale to members of the book club.

According to a further aspect of the present invention, a system for authors to efficiently promote their books to interested persons via a communications network is disclosed, the system comprising: a computer readable memory storing author information, at least one author classified, and at least one book club with associated book club information, wherein the computer readable memory provides promotion and a discussion forum of at least one author classified to at least one book club and offers a targeted item for sale to at least one member of the book club.

According to another embodiment, a method for providing a targeted author classified to at least one interested person and facilitating discussion regarding the targeted author classified is disclosed, the method comprising the steps of: receiving and storing in computer readable memory author information from at least one author; receiving and storing in computer readable memory at least one author classified from at least one author for at least one author classified item; receiving and storing in computer readable memory information regarding at least one reader; and presenting at least one author classified to at least one reader, wherein at least one author classified is selected according to information received and stored regarding at least one reader.

These and other features, aspects and advantages of the present invention will become better understood with reference to the following drawings, description and claims.

### BRIEF DESCRIPTION OF THE DRAWINGS

FIG. 1 depicts a system according to an embodiment of the present invention;

FIG. 2 depicts a flowchart according to an embodiment of the present invention;

FIGS. 3A-3B depict a screenshot of a form used according to an embodiment of the present invention;

FIGS. 4A-4D depict a screenshot of a form used according to an embodiment of the present invention;

FIG. 5 depicts a screenshot of a form used according to an embodiment of the present invention;

FIG. 6 depicts a screenshot of a form used according to an embodiment of the present invention;

FIGS. 7A-7B depict a screenshot of a form used according to an embodiment of the present invention;

FIG. 8 depicts a screenshot of an email according to an embodiment of the present invention;

FIG. 9 depicts a screenshot of a book club page according to an embodiment of the present invention;

FIG. 10 depicts a methodology according to an embodiment of the present invention; and

FIGS. 11A-11B depict an overview of an embodiment according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

It is envisioned that the present invention provides systems and methods for facilitating discussion book club meetings between an author and a book club over a network between member of the book club. It should be noted, that security measures as known within the art are intended throughout the systems and methods disclosed herein. This may include SSL and login measures at various points.

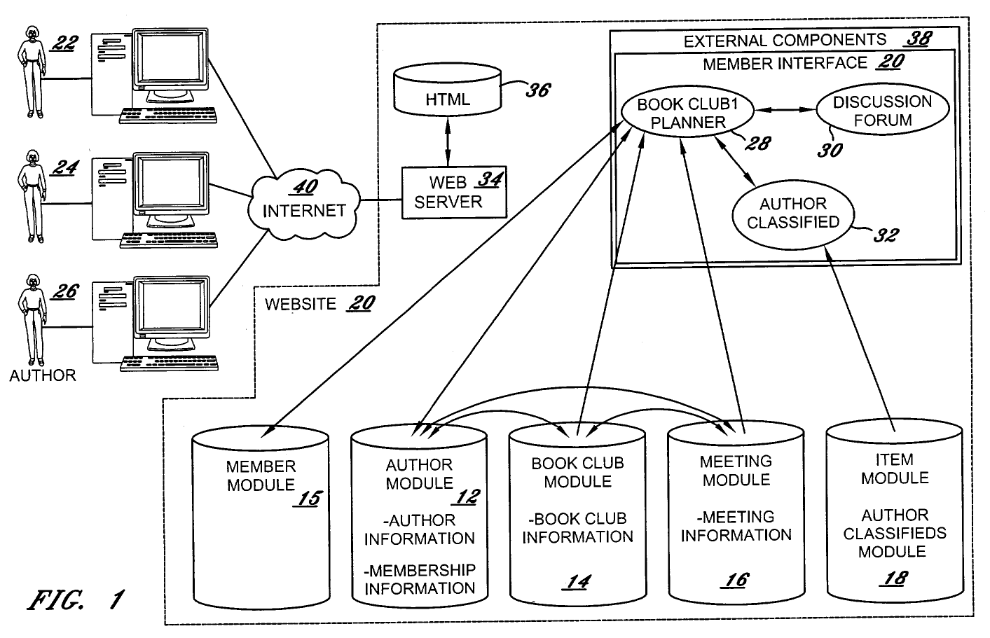

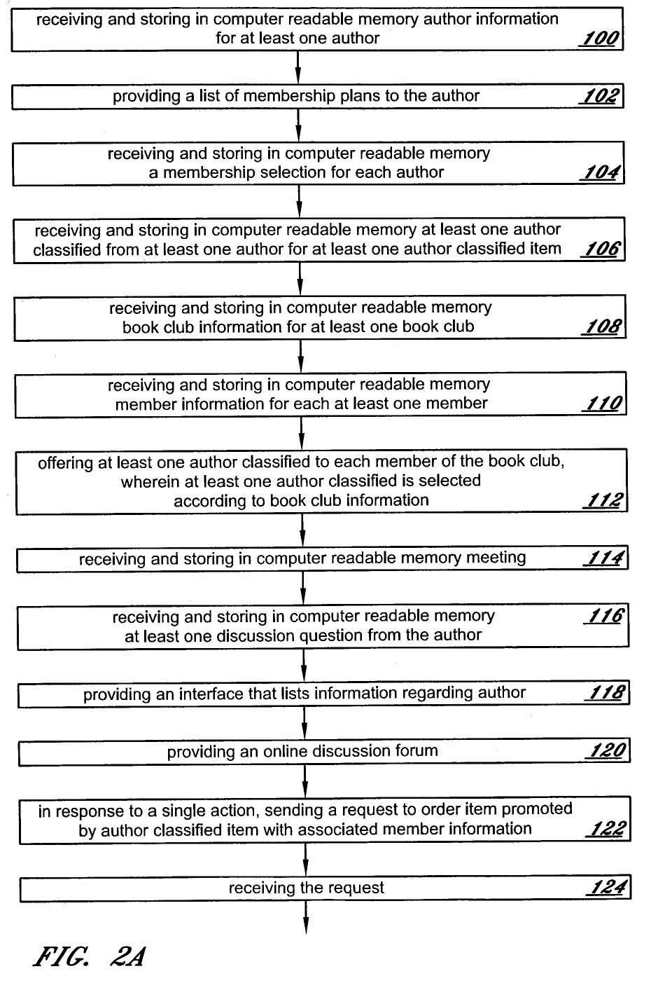

FIG. 1 depicts a system for providing meeting planning services for multiple members of a book club via a communications network according to one aspect of the present invention. The system is comprised of an author module 12 for collecting and storing author information, including membership information, regarding the author. Author information may include the authors first name, last name, email address, mailing address, city, town, state, province, zip code, country, make administrative contact, credit card information, telephone, birthday, membership information and attendance status. The system also has a book club module 14 for collecting and storing information relating to a book club, a meeting module 16 for collecting and storing meeting information relating to future meetings, and an item module 18 for collecting and storing information regarding an item such as a book, poem, electronic book, movie, DVD and compact disc. The item may be an author classified, which highlights an item by a particular author. Optionally, there may be a member module 15 for accepting information from members of a book club. It should be noted that this may be optional, because an author may first set up a book club, to highlight their works prior to there being any members. There is also an interface 20 for mediating communications via the communication network between the members (e.g. 22 and 24) of the book club and an author 26 and providing information from the author module 12, the book club module 14, the meeting module 16 and the item module 18 to provide a list of targeted items for sale to members (e.g. 22 and 24). Information may be exchanged or shared between the author module 12, book club module 14, meeting module 16 and item module 18. Each module may even be a contained within a larger single module or database, without limitation.

The member module 15 contains information regarding individual members (e.g. 22 and 24) such as first name, last name, email address, mailing address, city, town, state, province, zip code, telephone, birthday, make administrative contact, credit card info, contact information, and membership information. The book club module 14 contains book club information such as book club name, city, town, state, province, meeting since date, meeting location, relation of members, meeting frequency, who leads, genre, topic, last book read, desired reading topics. The meeting module 16 contains meeting information such as location, time, date, book selection, discussion topics. The item module 18 contains item information such as name, price, genre, etc. The information may vary depending on the item or author classified being presented.

It is intended that the interface 20 is a website which provides a forum for book clubs and their members to communicate with authors, and also to provide ease for authors to promote and members to purchase items of interest or related to upcoming meetings. For example, it may be desirable to provide a book club planner 28. The book club planner 28 may update members of the place, date, time, attendance, discussion topics and the like for upcoming meetings. The book club planner 28 may also notify author 26 of upcoming events they may be interested in. For instance, where a book club chooses a book written by the author 26, an email may be automatically generated to inform the author 26. The author may then provide discussion questions, topics or a readers guide, or schedule an online chat or discussion. There may also be a discussion forum 30, where members (e.g. 22 and 24) may post topics of interest. All the members may be reading the same book and comment on a particular portion of the book, or other books that may be of interest. Also, the author may pose and/or respond to questions for the members on the author's web page. It is also intended that the interface 20 provide author classifieds 32 to the members (e.g. 22 and 24). By way of example, author classified may be for a book the book club has selected or one that is of a similar genre to those that the book club has read in the past. The author classified 32 may also be a movie made from the book that they are reading, electronic books, movies, DVD's, compact disc's or any other item for which book clubs may meet to discuss or which may be particularly relevant to a discussion group. The interface 20 may also include public and private discussion boards. The private discussion board may be viewable only to members of the club. The public discussion board may viewable to anyone at the website. There may also be an inter-group discussion board, which is only viewable by people who are a member of at least one book club.

One of the reasons people may join book clubs is to gather information and guidance from others members and outside influences. The item module may contain information regarding items, such that if a member likes one item, a similar item would be a good recommendation. For example, where a reader liked Tom Wolfe's “A Man in Full”, it may be wise to offer Tom Wolfe's “Bonfire of the Vanities” or a Nelson Demille novel. The present invention also enables the authors to speak and interact with to their readers.

The web server 34 may communicate with various external components 38. This may include a search engine and associated databases for enabling users to search for particular items, processing components allowing for the purchase of targeted items for sale 32, shopping carts, item information catalogs, related group/book club webpage's, and webpage's of interest. The website 20 includes a web server 34 which accesses a database 36 of HTML (hypertext markup language) content which includes information regarding the author, members, group, targeted items for sale, upcoming meetings, discussion forums and other items of interest, such as author inspired discussion questions.

Also envisioned is a system for facilitating book club discussion group meetings over a network. The system comprising: a computer readable memory storing, such as a web server 34, author information (may be in the author module 12), at least one author classified (may be stored in the item module 32), and at least one book club with associated book club information (may be stored in the book club module 14), wherein the computer readable memory provides promotion and a discussion forum for at least one author classified to a book club and offers a targeted item for sale to members of the book club. The targeted item for sale may be the item within the author classified. An author classified may contain one or more items for sale. It is envisioned that the items for sale be those authored by the author.

According to a preferred embodiment, a method for providing a targeted author classified to at least one interested person and facilitating discussion regarding the targeted author classified is disclosed which may consist of a number of steps. It should be understood that the order of these steps in not essential, and they may be performed in a variety of orders. The method may comprise the step 100 of receiving and storing in computer readable memory author information from at least one author. The step 102 providing a list of membership plans to the author. The step 104 may be receiving and storing in computer readable memory a membership selection for each author. The step 106 receiving and storing in computer readable memory at least one author classified from at least one author for at least one author classified item. The author classified item is selected from the group consisting of a book, poem, electronic book, movie, DVD and compact disc. The step 108 receiving and storing in computer readable memory book club information for at least one book club. Book club information may be selected from the group consisting of name, city, town, state, province, meeting since date, meeting location, relation of member, meeting frequency, who leads, genre, topic, last book read, desired reading topics and attendance status. The step 110 receiving and storing in computer readable memory member information for each at least one member. The step 112 offering at least one author classified to each member of the book club, wherein at least one author classified is selected according to book club information. The step 114 receiving and storing in computer readable memory meeting information. Meeting information may be selected from the group consisting of location, time, date, book selection, discussion topics, and attendance status. The step 116 receiving and storing in computer readable memory at least one discussion question from the author. The step 118 providing an interface that lists information regarding author. The step 120 providing an online discussion forum. The method may include the step 122, in response to a single action, sending a request to order item promoted by author classified item with associated member information, step 124 receiving the request, step 126 retrieving member information stored in the computer readable medium required to purchase author classified item, step 128 fulfilling the generated order to provide a purchased item, step 130 delivering the purchased item to the member, step 134 sending a confirmation email to the member confirming purchase of the purchased item. There may be the step 136 providing reminders to the author regarding upcoming meeting of book clubs that may be of interest, step 138 providing targeted incentives to the members. Step 140, receiving and storing in a computer readable memory book club information for at least one book club. Step 142 receiving and storing in computer readable memory author information from at least one author. Step 144 mailing list capability on each web page. Step 146 receiving and storing in computer readable memory a mailing list. Step 148 sending information to each person on the mailing list. Step 150 providing each at least one member with a list of book clubs from computer readable memory. Step 152 receiving and storing in computer readable memory a book club selection from member. Step 154 receiving and storing in computer readable memory at least one classified, wherein the classified contains at least one author classified item for sale. Step 156 receiving and storing in computer readable memory a list of items for sale, wherein the list of items may includes at least one author classified item. Step 158 categorizing the list of items to provide a list of categories for each item. Step 160 offering at least one item in the list of items to members of the book clubs and mailing list, wherein at least item is selected according to book club and list of categories. The author classified is selected and presented according to book club information. Step 162, providing an online discussion forum wherein the author may communicate with members of the book club. Step 164 providing targeted incentives to the members.

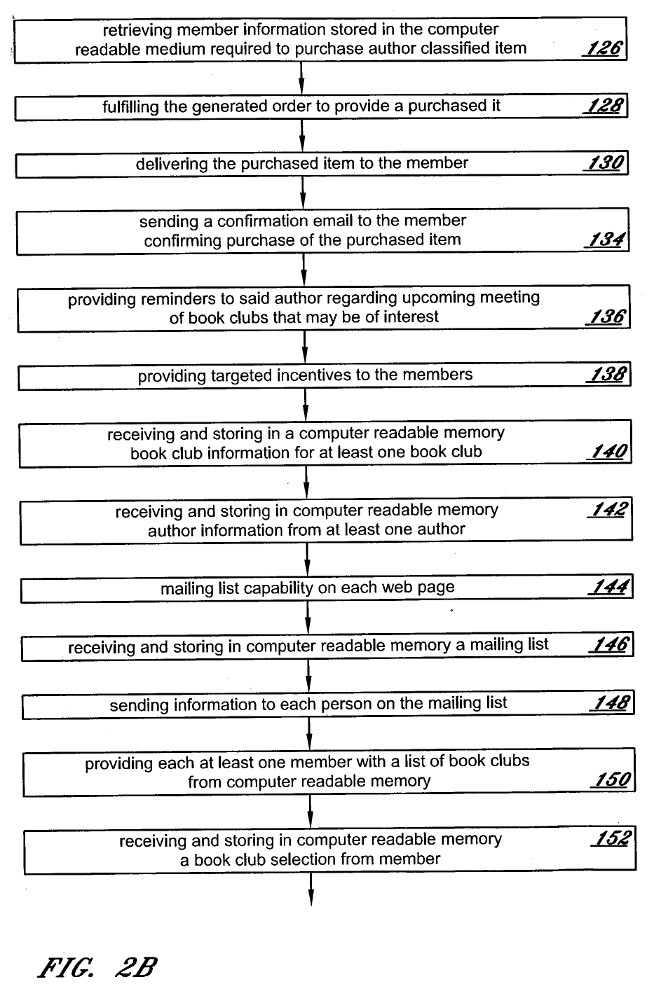

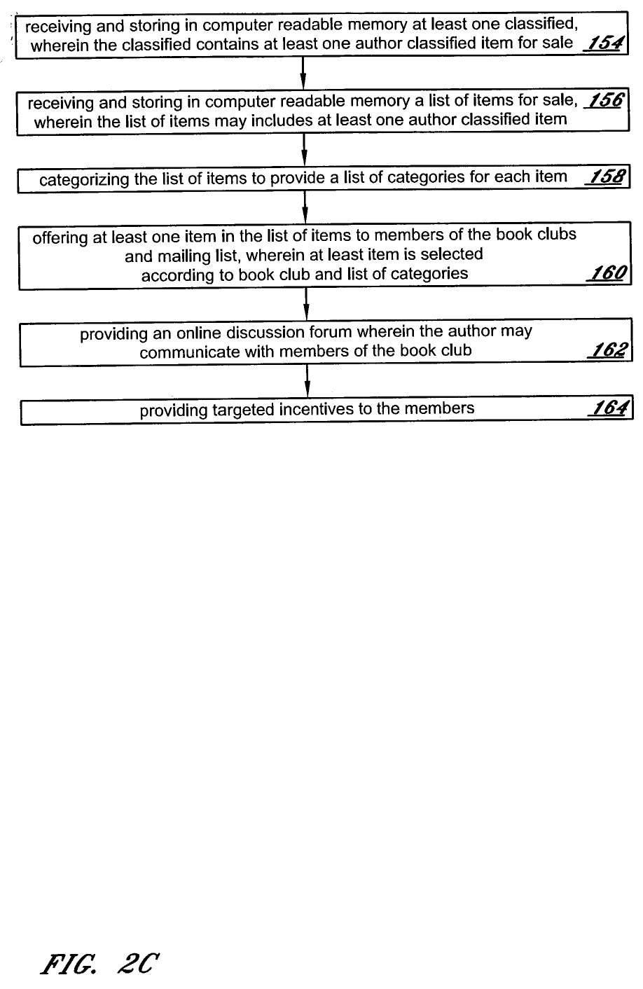

Referring now to FIGS. 3-9 together, FIG. 3A depicts a manner in which step 100 of receiving and storing in computer readable memory author information from at least one author. As show, form 300 may be used to receive and store author information (which may be stored in a database, such as author module 12) for each member (e.g. 22, 24, 25). The form 300 include spaces to receive and storing member information including the first name 302, last name 304, email 306, mailing address 308, city/town 310, state/province 312, zip code 314, telephone 316, and birthday 318. It may be offered to send occasional email announcements regarding special sales, events and promotions 320. Also, member information may include information relating to updates and whether the member is also an administrative contact 322. Information may be stored by clicking on a continue or save changes button 324.

FIG. 3B depicts a step in which the author 26 may create a book movement account. As shown, the author 26 inputs their first name 302, last name 304, and email address 306. The author 26 may then chose a login identity with a username 326 and password 328 (optionally they may confirm the password 330). Information may be stored by clicking on a continue 332 button.

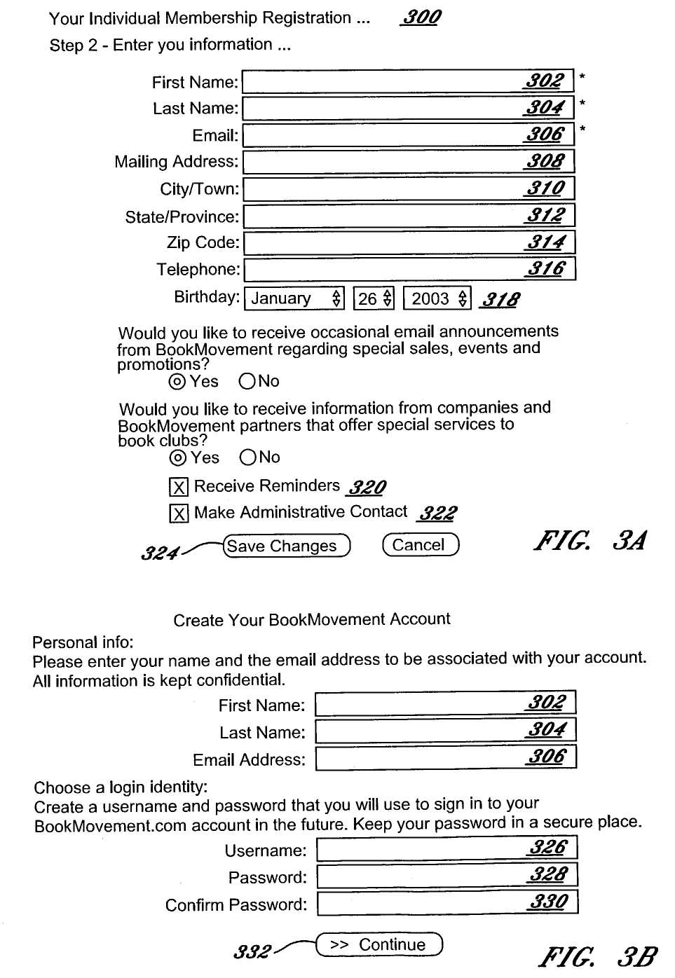

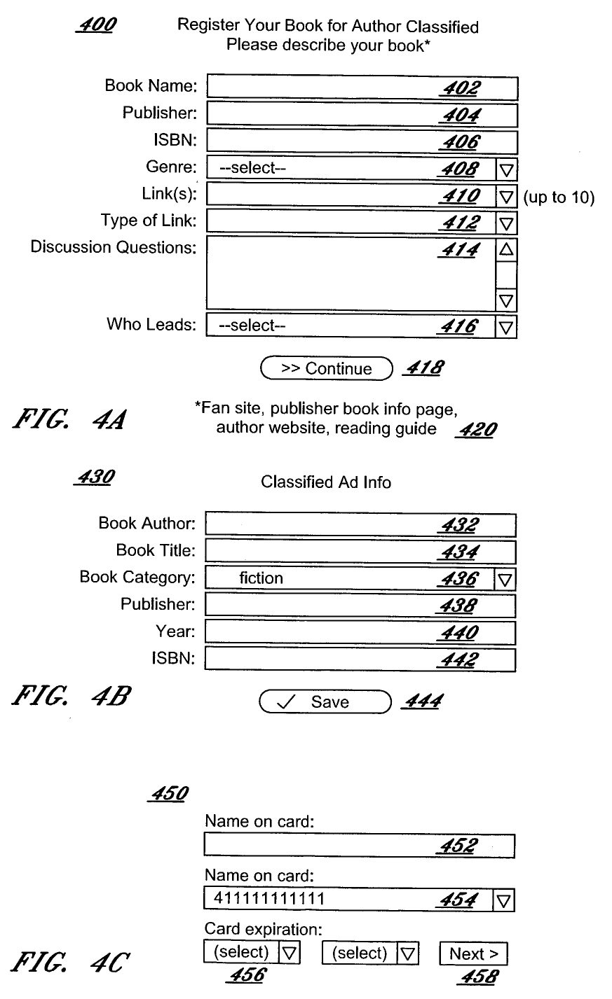

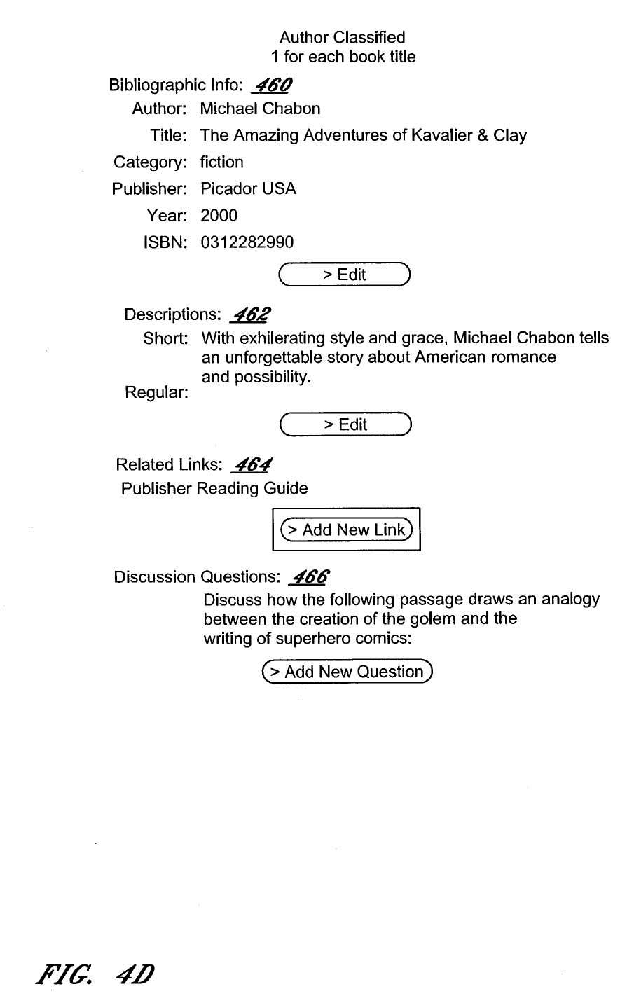

FIGS. 4A-4D depict the step 106 receiving and storing in computer readable memory at least one author classified from at least one author for at least one author classified item. The example shown in FIG. 4A is for a book, and the author may input the book name 402, publisher 404, ISBN 406, Genre 408, links 410, type of link 412, discussion questions 414 and who leads 416. In order to save the information, the button continue 416 is clicked. There may also be additional information provided such as fan site, publisher book info page, related author website and reading guides 420.

FIG. 4B depicts Classified Ad Info for a single item. As shown, by form 430, information is inputted including book author 432, book title 434, book category 436, publisher 438, year 440 and ISBN 442 may be input. In order to save the information the save 444 button may be clicked. The next step is depicted by form 450, FIG. 4C, and may be to input credit card information including name 452, card number 454 and expiration 456. By clicking next 458, the information is sent.

FIG. 4D depicts a sample author classified and associated author classified information. As shown, bibliographic info 460 including author, title category, publisher, year, and ISBN are shown. There may be a description 462, related links 464, and discussion questions 466.

FIG. 5 depicts a screen shot 500. As shown, a summary of the information is provided and the author may verify the information. This may be the title 500, publisher 504, ISBN 506, links 508, discussion questions 510, who leads 512, genre 514, username 518, email 520, last name 526, first name 524, address 528, city 530, state 532, zip 534, birthday 538, offers 540. The forms may be edited by clicking the edit buttons 516 and 542. Information may be stored by clicking on the continue button 544.

This application is a continuation in part of application Ser. No. 10/295,353 filed Nov. 15, 2002. That application discloses the book club web page, wherein a book club and member are provided a forum to plan and discuss upcoming meetings and talk. It is envisioned that the present application and the previous application would link to one another, and book club home pages would link to certain author classifieds and author pages. Also, some author pages may link to book club websites reading items they've authored. Where one member signs up the book club, they may want to create a mailing list of the other members as in step 160.

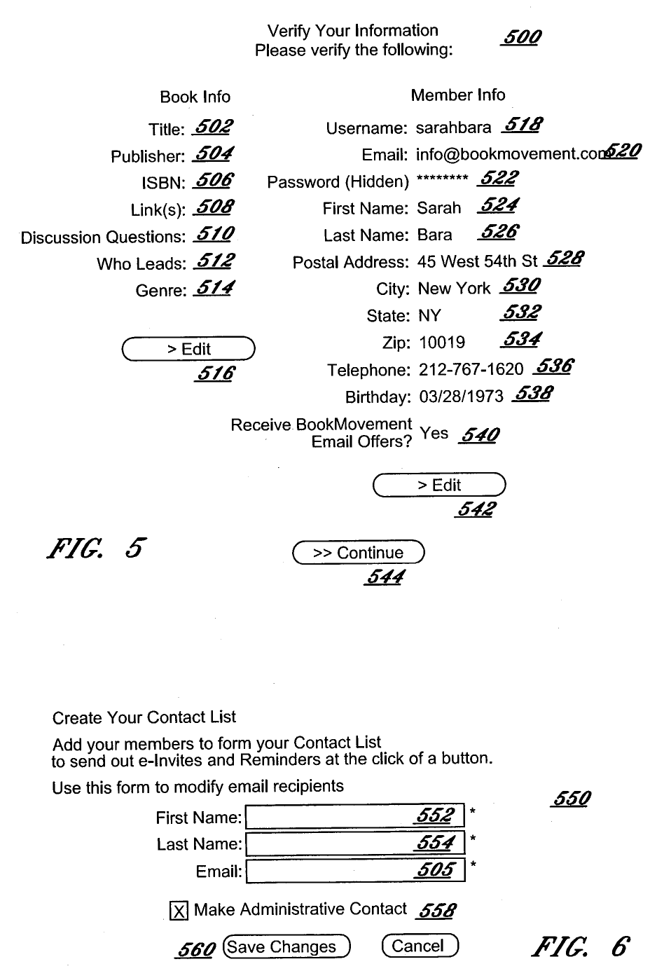

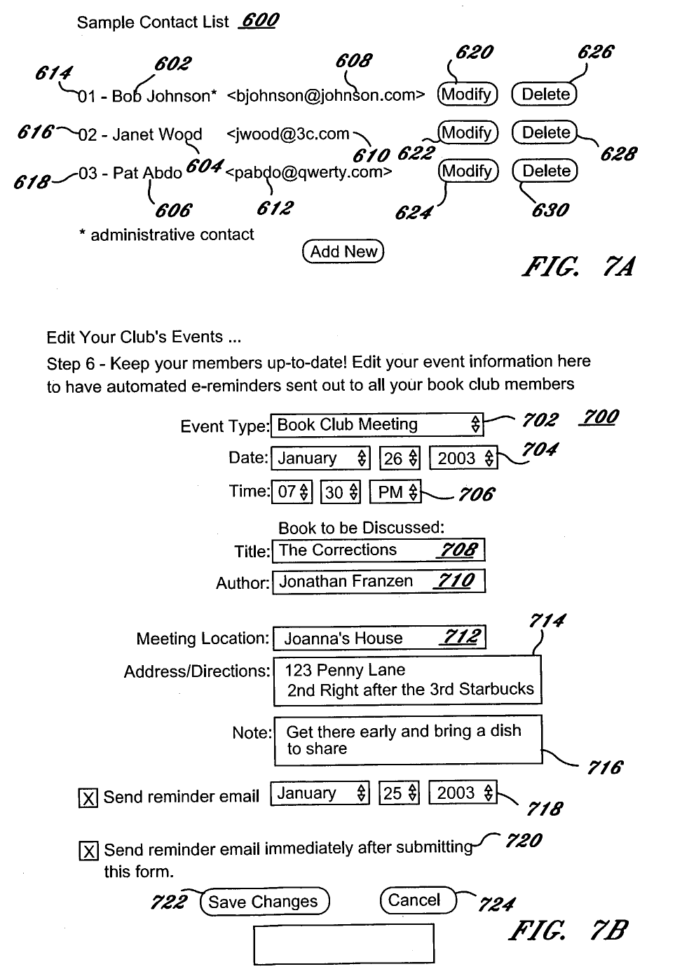

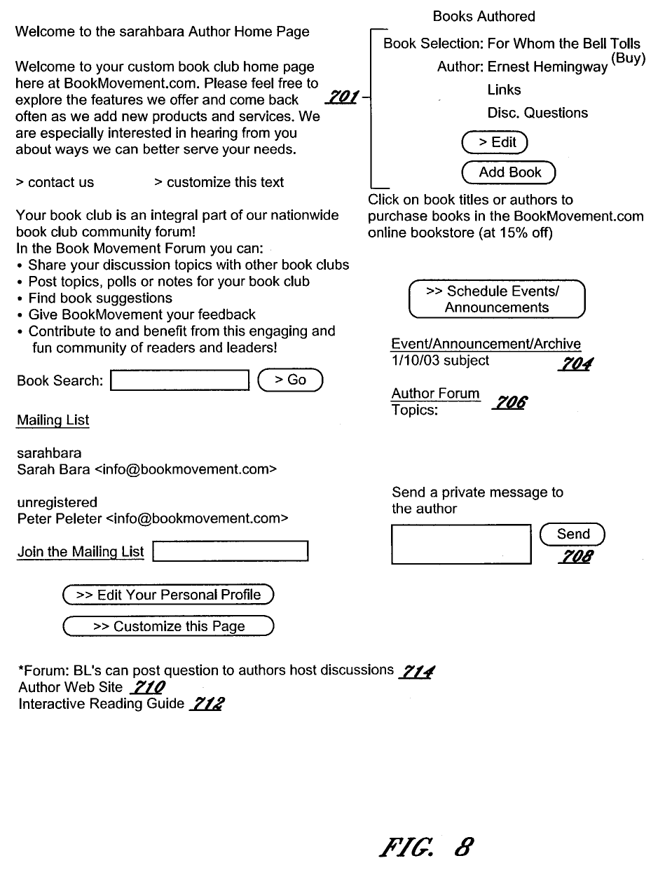

FIG. 6 depicts a form 550 for creating a mailing list. As shown, the first name 552, last name 554 and email 556 of other members may be input. Also, one member or more may be granted administrative privileges by checking the make administrative contact box 558. Information contained within the form 550 is stored upon clicking the save changes 560 button. The system, according to the present invention, will create a mailing list 600, as shown in FIG. 7. By way of example, this may list the name of members (e.g. 602, 604, 606) and associated emails (e.g. 608, 610, 612). Also, identifiers (e.g. 614, 616, 618) may be associated with members (e.g. 602, 604, 606). Information contained within the mailing list 600 may be modified by clicking button 620, 622, 624 or deleted by clicking 626, 628, 630. On author web page, there will also be a box where readers can type in their email address to join the mailing list.

A manner in which step 114 receiving and storing in computer readable memory meeting and announcement information is accomplished is shown in FIG. 7B. Form 700 accepts meeting information such as the event/announcement type 702, date 704, time 706, title 708, author 710, meeting location 712, address directions, 714, notes 716, email reminders 718, automatic emailing options 720. Step 162 editing said meeting information to provide meeting changes for a book club may utilize the same form 700. Where changes are to be effectuated, the member filling the form 700 may click 722. In this way, changes may be automatically emailed to all the members of the book club, and changes updated to the website.

Step 118 providing an interface that lists information regarding author may look like FIG. 8. As shown the mailing list with names (e.g. 602, 604, 606) and associated emails (608, 601, 612) is shown. Author classifieds 702 may show a number of different titles. There may also be an author forum 706, which may have upcoming events/announcements 704. There may also be the option of sending a private message to the author 708. This information may be manually input by any individual (authors, members, salespeople, etc.). The author classified may only be input by the author or someone with administrative privileges. Item information may be imported from a separate database to provide a wide range of items available to members. There may also be a link to an author web site 710 or an interactive reading guide 712 for the authors book. There may also be a forum 714 where book clubs can post questions to authors and host discussions.

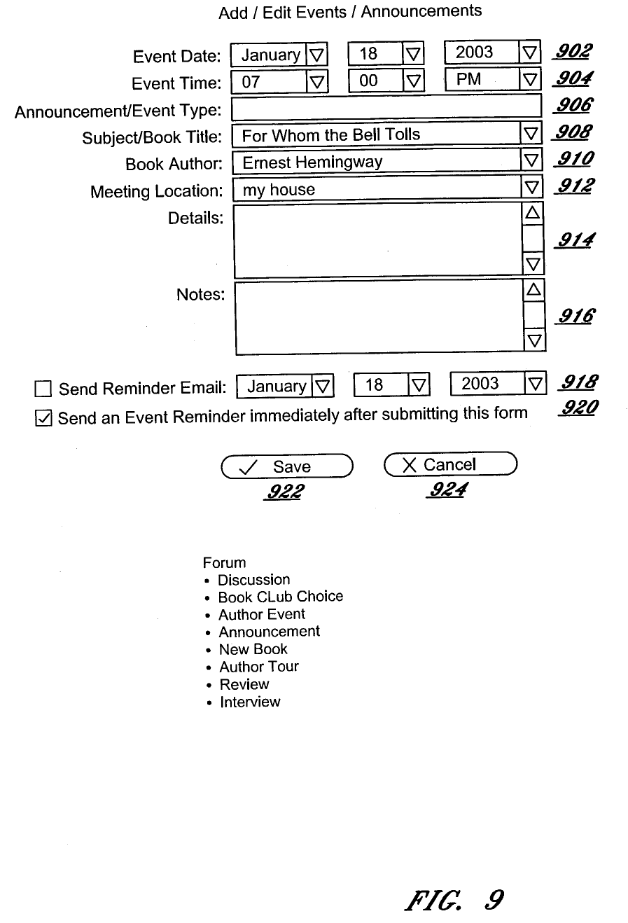

FIG. 9 depicts a manner in which events may be edited added or announced to the mailing list. As shown, an individual with administrative privileges may input the event date 902, time 904, announcement/event type 906, book title 908, book author 910, location 912, details 914, notes 916, reminder email 918, checked item 920. Checked items may include a number of offers, such as send an event reminder immediately after submitting this form. The person with administrative privileges may either save 922 the changes or cancel 924. It should be noted that the author may also form their own book club and host discussion in their own forum.

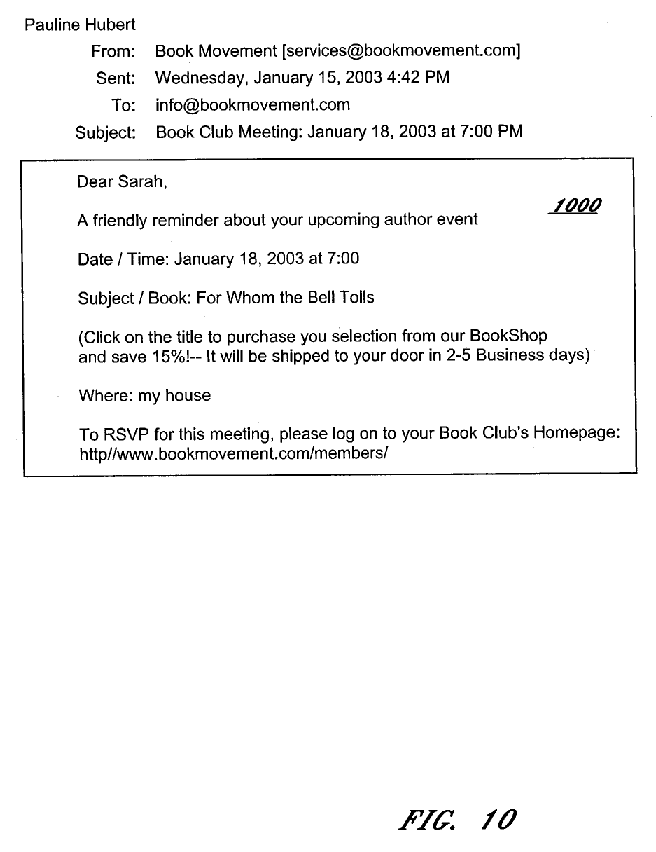

FIG. 10 depicts a sample reminder that may be generated. As shown, there may an automatically generated email 1000 sent to everyone on the mailing list. It should be noted that the mailing list may be generated by authors, members of a book club and visitors to the site.

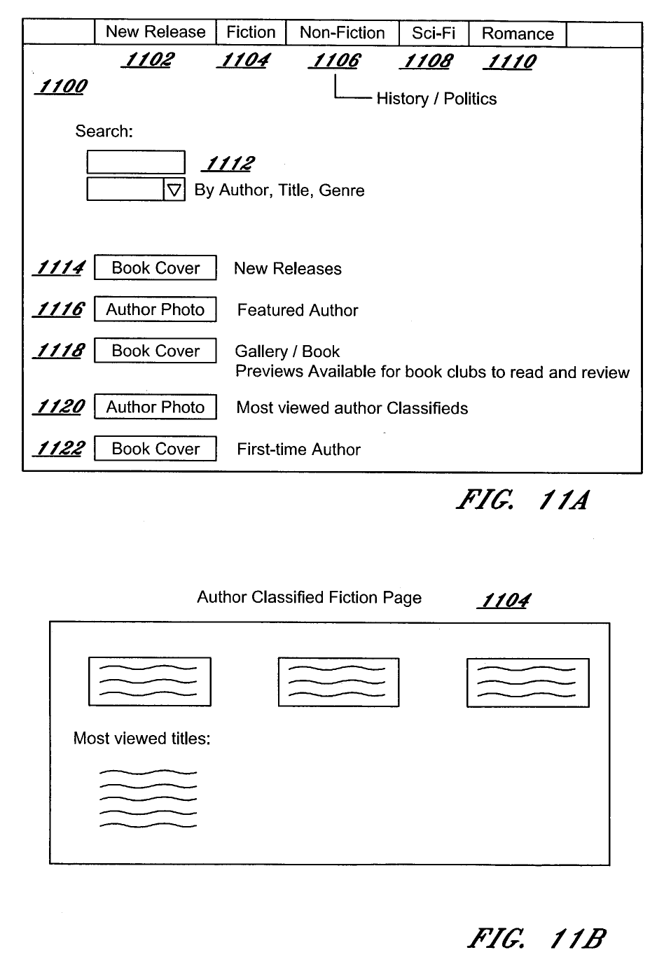

FIGS. 11A and 11B, depicts an author services home page 1100. As shown, there may be a new releases 1102 section, fiction 1104, non-fiction 1106, sci-fi 1108 and romance 1110. There may be a search option 1112. New releases 1114, upcoming releases in galley form available to preview, read, review and recommend, featured books/authors, first-time authors, and optioned books may be prominently displayed and there may be a photo 1116. As shown, when the fiction page is clicked on author classifieds fiction page 1104 may be viewed. This page 1104 may show the most viewed titles. There may also be a book galley 1118 with previews available for book clubs to read and review. the most viewed author classifieds 1120 may also be viewed and a recommended first time author 1122.

There may be many different types of pages, discussion boards and viewable information including the author classified pages and author pages. Some may be publicly viewable, some viewable only to authors, some viewable only to members the book club, and some only view to people who are members of at least one book club. It is intended that book club pages, and author classified pages be viewable to members and potential members. Also, it is envisioned, that authors and more than one the book club share information regarding topics, ideas, suggestions, etc. Inter-book club communication is generally shared on a page separate from the book club page, such as an inter-book club discussion board. It should be understood, that there may be both book club discussion boards, only visible to those members of the book club and inter-book club discussion boards which may be visible to the public or those individuals signed up as members of at least one book club. Author classifieds may also be offered for sale at the book club page 900.

It is a purpose of the present invention to facilitate and streamline communication between authors and their intended audience (reader, listener, etc.). The present invention also envisions providing targeted items for sale/incentives to its members. This may include discounts, information, publication dates, author readings, books becoming movies, pre-publications books, author inspired discussion questions, book club buying discounts. The present invention also allows for interactive content between authors and their readers.

It should be understood, of course, that the foregoing relates to preferred embodiments of the invention and that modifications may be made without departing from the spirit and scope of the invention as set forth in the following claims.

I claim:

1. A system for authors to efficiently promote their books to interested persons via a communications network, the system comprising:
an author module for collecting and storing author information;
an item module for collecting and storing book and writing information relating to at least author classified;
an interface for displaying said author information and said at least one author classified written by said author;
a book club module for collecting and storing book club information relating to a book club comprised of an least one member; and
an interface for mediating communications via the communication network between the members of said book club and said author, and providing information from said author module, said item module, and said book club module to provide discussion topics and offers at least one targeted said author classified for sale to members of said book club.

2. A system as in claim 1, further comprising a member module, wherein said member module accepts member information from at least one member of a book club.

3. A system as in claim 2, wherein said member information is selected from the group consisting of is selected from the group consisting of first name, last name, email address, mailing address, city, town, state, province, zip code, country, make administrative contact, credit card information, telephone, birthday, membership information and attendance status.

4. A system as in claim 1, further comprising a meeting module for collecting and storing meeting information relating to at least one meeting.

5. A system as in claim 4, wherein said meeting information is selected from the group consisting of location, time, date, book selection, attendance status, and discussion topics.

6. A system as in claim 1, wherein said author information is selected from the group consisting of first name, last name, email address, mailing address, city, town, state, province, zip code, country, make administrative contact, credit card information, telephone, birthday, membership information and attendance status.

7. A system as in claim 1, wherein said step of providing an interface for mediating communications via the communication network between the members of said book club and said author is further comprised of the step of said author providing said members of said book club with an interactive reading guide.

8. A system as in claim 1, wherein said book and writing information is selected from the group consisting of name, price, publisher, ISBN, genre, links, discussion questions, fans site, author web site, book reviews and author interviews, reading guide, discussion topic, related books, new releases and publisher information.

9. A system as in claim 1, wherein said book club information is selected from the group consisting of name, city, town, state, province, meeting since date, meeting location, relation of member, meeting frequency, who leads, genre, topic, last book read, attendance status, and desired reading topics.

10. A system for authors to efficiently promote their books to interested persons via a communications network, said system comprising:
a computer readable memory storing author information, at least one author classified, and at least one book club with associated book club information, wherein said computer readable memory provides promotion and a discussion forum of said at least one author classified to at least one said book club and offers a targeted item for sale to at least one member of said book club.

11. A system as in claim 10, wherein said computer readable memory further comprises member information for at least one member.

12. A system as in claim 11, wherein said member information is selected from the group consisting of first name, last name, email address, mailing address, city, town, state, province, zip code, country, make administrative contact, credit card information, telephone, birthday, membership information and attendance status.

13. A system as in claim 10, wherein said meeting information is selected from the group consisting of location, time, date, book selection, discussion topics and attendance status.

14. A system as in claim 10, wherein said book club information is selected from the group consisting of name, city, town, state, province, meeting since date, meeting location, relation of member, meeting frequency, who leads, genre, topic, last book read, desired reading topics and attendance status.

15. A system as in claim 10, wherein said author information is selected from the group consisting of first name, last name, email address, mailing address, city, town, state, province, zip code, country, make administrative contact, credit card information, telephone, birthday, membership information and attendance status.

16. A method for providing a targeted author classified to at least one interested person and facilitating discussion regarding said targeted author classified, said method comprising the steps of:
receiving and storing in computer readable memory author information from at least one author;
receiving and storing in computer readable memory at least one author classified from said at least one author for at least one author classified item;
receiving and storing in computer readable memory information regarding at least one reader; and
presenting at least one author classified to said at least one reader, wherein said at least one author classified is selected according to information received and stored regarding said at least one reader.

17. A method as in claim 16, wherein said reader is a book club member, and the method further comprises the step of receiving and storing in computer readable memory book club information for at least one book club.

18. A method as in claim 17, wherein said at least one author classified is selected and presented according to said book club information.

19. A method as in claim 17, wherein said book club information is selected from the group consisting of name, city, town, state, province, meeting since date, meeting location, relation of member, meeting frequency, who leads, genre, topic, last book read, desired reading topics and attendance status.

20. A method as in claim 16, wherein said meeting information is selected from the group consisting of location, time, date, book selection, discussion topics, and attendance status.

21. A method as in claim 16, further comprising the steps of:
providing a list of membership plans to said author; and
receiving and storing in computer readable memory a membership selection for each said author.

22. A method as in claim 16, further comprising the steps of:
receiving and storing in computer readable memory at least one discussion question from said author.

23. A method as in claim 16, further comprising the step of:
providing an interface that lists information regarding said author.

24. A method as in claim 16, further comprising the step of:
providing an online discussion forum.

25. A method as in claim 16, further comprising the steps of:
in response to a single action, sending a request to order item promoted by said author classified item with associated member information;
receiving said request;
retrieving member information stored in said computer readable medium required to purchase said author classified item;
fulfilling the generated order to provide a purchased item; and
delivering to said purchased item to said member.

26. A method as in claim 25, further comprising the step of:
sending a confirmation email to said member confirming purchase of said purchased item.

27. A method as in claim 16, further comprising the steps of:
providing reminders to said author regarding upcoming meeting of book clubs that may be of interest.

28. A method as in claim 16, further comprising the steps of:
providing targeted incentives to said members.

29. A method as in claim 16, wherein said author classified item is selected from the group consisting of a book, poem, electronic book, movie, DVD and compact disc.

30. A method for facilitating on and offline book club discussion group meetings over a network between members of the book club and an author, said method comprising the steps of:
receiving and storing in a computer readable memory book club information for at least one book club;
receiving and storing in computer readable memory author information from at least one author;
providing each said at least one member with a list of book clubs from said computer readable memory;
receiving and storing in computer readable memory a book club selection from said member;
receiving and storing in computer readable memory at least one author classified, wherein said at least one author classified contains at least one author classified item for sale;
receiving and storing in computer readable memory a mailing list;
receiving and storing in computer readable memory a list of items for sale, wherein said list of items may includes said at least one author classified item;
categorizing said list of items to provide a list of categories for each said item;
offering at least one item in said list of items to members of said book clubs and said mailing list, wherein said at least item is selected according to said book club and said list of categories; and
providing an online discussion forum wherein said author may communicate with said members of said book club.

31. A method as in claim 30, wherein said book club information is selected from the group consisting of name, city, town, state, province, meeting since date, meeting location, relation of member, meeting frequency, who leads, genre, topic, last book read, desired reading topics.

32. A method as in claim 30, wherein said member information is selected from the group consisting of first name, last name, email address, mailing address, city, town, state, province, zip code, country, make administrative contact, credit card information, telephone, birthday, membership information and attendance status.

33. A method as in claim 30, further comprising the step of receiving and storing in a computer readable memory meeting information.

34. A method as in claim 33, wherein said meeting information is selected from the group consisting of location, time, date, book selection, and discussion topics.

35. A method as in claim 30, further comprising the steps of:
providing targeted incentives to said members.
